(19) United States
(12) Patent Application Publication
(10) Pub. No.: US 2025/0252397 A1
(43) Pub. Date: Aug. 7, 2025

(54) LIFECYCLE MANAGEMENT AT A PROCESSING FACILITY

(71) Applicant: MicroWest Design Ltd., Prince George (CA)

(72) Inventor: Glenn Erwin Zuhlke, Prince George (CA)

(21) Appl. No.: 19/032,883

(22) Filed: Jan. 21, 2025

(30) Foreign Application Priority Data
Feb. 1, 2024 (CA) 3227888

(51) Int. Cl. G06Q 10/0875; G06Q 10/0633; G06Q 50/02

(52) U.S. Cl. CPC G06Q 10/0875; G06Q 10/0633; G06Q 50/02

(57) ABSTRACT

A method of tracking timber packages in a timber yard includes producing a plurality of timber packages that are characterized by a set of specifications and transporting the timber packages within the timber yard using transport equipment that has location and load sensors. For each timber package, detecting loading and unloading event when the timber package is loaded onto or unloaded from the transport equipment, each event comprising a detected location and a set of specifications. The timber packages are processed at the processing location to modify the set of specifications as a processing event. For each loading event, each unloading event, and each processing event, a package record is recorded in a computer system that includes the detected location and the set of specifications.

### TECHNICAL FIELD

This relates to a system for managing the lifecycle of a product at a processing facility, and in particular, a system that manages the lifecycle of a product by tracking pickup, drop off, and processing events at a facility.

### BACKGROUND

Processing facilities, such as timber yards that process logs and/or lumber, are required to track raw materials arriving at the facility, finished products leaving the facility, and processing steps between. This is useful for proper planning, appropriate use of resources, and to avoid spoilage of products that may degrade or change over time.

A timber yard, which may also be referred to as a lumber yard, may vary depending on location, capabilities, equipment, the types of wood being managed, and the intended products. As used herein, the term “timber” is used in a general sense to refer to wood products at various stages, including logs as delivered to a timber yard, rough cut lumber, planed lumber, and lumber In general, a timber yard may have a sorting line to sort logs as they arrive based on characteristics such as species and/or dimensions, and processing equipment, such as mills, kilns, planers, etc. A timber yard may also have various staging or storage areas for logs or lumber at different stages of processing, which may include be open, covered, or enclosed spaces.

U.S. Pat. No. 5,604,715 (Aman et al.) entitled “Automated Lumber Unit Trucking System” describes a system that tracks the location of objects in a lumber yard as they are moved by forklifts based on the detected location of the forklift and the weight measured by the forklift.

### SUMMARY

According to an aspect, there is provided a method of tracking timber packages in a timber yard, the method comprising the steps of: milling logs at a mill to produce a plurality of timber packages, each timber package being characterized by a set of specifications; transporting the plurality of timber packages between locations within the timber yard using transport equipment that comprises a location sensor and a load sensor; and for each timber package: detecting loading events when the timber package is loaded onto the transport equipment, each loading event comprising a detected location and a measured load, the loading events comprising a first loading event detected at an output of the mill and at least one processing location; detecting unloading events when the timber package is unloaded from the transport equipment in the timber yard, each unloading event comprising a detected location and a set of specifications; processing the timber package at the processing location to modify the set of specifications as a processing event; and for each loading event, each unloading event, and each processing event, recording a package record in a computer system comprising the detected location and the set of specifications; and loading an unknown timber package at a location.

According to further aspects, the method may comprise one or more of the following features, alone or in combination: the set of specifications may comprise wood species, moisture content, age, event time stamps, package weight, dimensions of the timber package, dimensions of individual logs or lumber pieces in the timber package, or combinations thereof; the timber yard may comprise log bins comprising logs sorted according to characteristics, and wherein a location of each log bin and the characteristics are stored in the computer system as a bin record, the method further comprising the steps of delivering logs from log bins to the mill using the transport equipment and associating the location of the transport equipment with the log bins to verify characteristics of the logs being delivered to the mill; the method may comprise the step of directing an operator to a location of a timber package selected based on the set of specifications; processing the timber package may comprise drying the timber package in a kiln, and the specifications comprise a moisture content of the timber package; processing the timber package may comprise planing the timber package in a planer, at least some of the plurality of timber packages being transported from the kiln to the planer; a plurality of timber packages may be processed in a processing facility and a plurality of processed timber packages may be packaged after the processing event, the plurality of timber packages may share at least one common characteristic such that lumber in the plurality of timber packages is fungible between the plurality of processed timber packages; the computer may be programmed to estimate a modified specification after processing by a lumber processor, and the modified specification is used to verify an identity of a processed timber package; the method may further comprise the step of unloading one or more timber packages in a storage location of the timber yard; and the method may further comprise the step of applying a machine-readable code to the timber package.

According to an aspect, there is provided a lifecycle management system for a timber yard, comprising transport equipment configured to transport timber packages at the timber yard, the transport equipment having a location sensor and a load sensor; at least one timber processor that processes the timber packages in processing events; and a computer processor that is programmed to: track a location of the transport equipment as the transport equipment loads and unloads timber packages; store package records for each load event, unload event, or processing event of a timber package, each package record comprising a location and a set of specifications of the timber package; identify an unknown timber package by comparing characteristics of the timber package to the stored package records; and track the milled package from the timber processor to a subsequent location.

According to further aspects, the lifecycle management system may further comprise one or more of the following features, alone or in combination: the computer processor may be programmed to receive a timber order and direct an operator to one or more timber packages that corresponds to the timber order; the timber yard may further comprise additional processing equipment that comprises a kiln, a planer, or a kiln and a planer, and the computer processor may be further programmed to track timber packages between more than one timber processors based on the location of the transport equipment, and update the set of specifications for the timber packages processed by a subsequent one of the more than one timber processors; the timber yard may further comprise a storage location for storing timber packages that are packaged downstream of the mill; the set of specifications may comprise an age of timber, weight of timber, moisture of timber, species of timber, dimensions of timber, or combinations thereof; the computer processor may be programmed to use a physical location of a package as a unique identifier of the package; the computer may be programmed to estimate a modified specification after processing by a lumber processor, and the modified specification is used to verify an identity of a processed timber package; there may be a code reader that is adapted to read a machine-readable code applied to timber package; the computer processor may be further programmed to manage lumber in a plurality of the timber packages that share at least one predetermined common characteristic as fungible between a plurality of processed timber packages that result from the processing event.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic of a system for managing the lifecycle of a product at a processing facility.

### DETAILED DESCRIPTION OF PREFERRED EMBODIMENTS

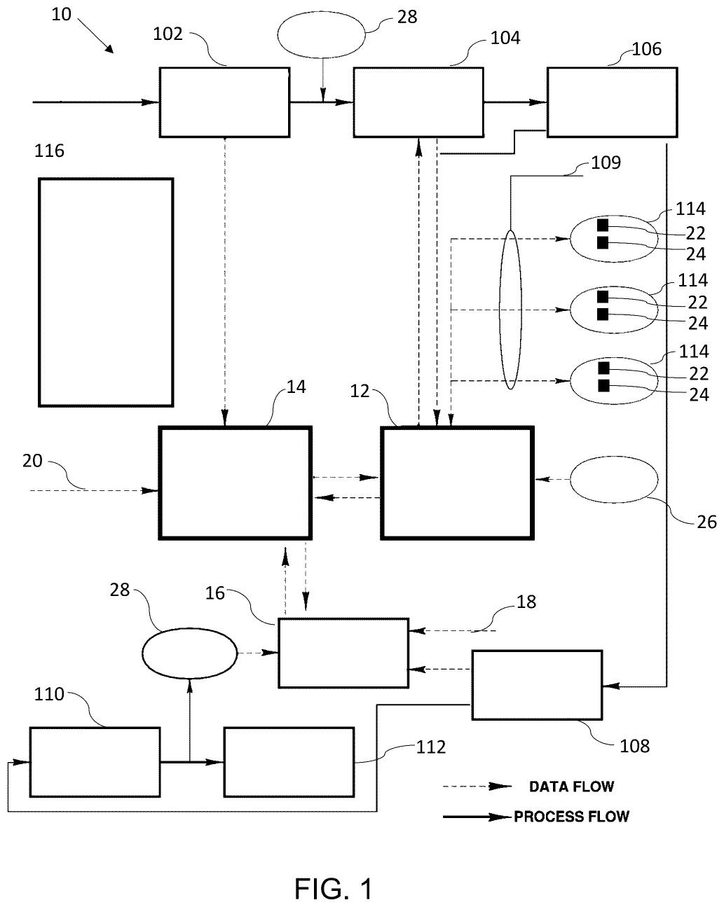

A system, generally indicated by reference number 10, and method for managing the lifecycle of products at a processing facility, will now be described with reference to FIG. 1.

The management system described below was developed for use with tracking material as it progresses through a timber yard, starting with logs delivered to the timber yard through to the final product produced at the timber yard. In the context of a timber yard, the system may be modified to account for different inputs and different outputs. For example, while logs delivered to a timber yard will generally be delimbed for ease of transport, the logs may be at different stages of processing, and may have been previously cut-to-length, debarked, and/or milled or rough cut by a sawmill at a different location. The output of the timber yard may be the output of a sawmill, kiln, or planer, or combinations thereof, depending on the desired products and the capabilities of the timber yard. The timber yard may have a storage area to store logs or lumber at any given stage of the process. The timber yard may also produce other products, such as plywood, fiberboard, particleboard, mulch, sawdust, etc. and the system may be modified to account for these products or waste streams.

While developed initially with respect to tracking timber in a timber yard, the system may also be applied to other types of processing facilities, where one or more processing steps are applied to input materials to produce final products. The discussion below will be given in terms of a timber yard, with the understanding that the principles discussed may be applied to other facilities in which material is packaged in bundles that is moved between locations in a defined area, and where the packaged material is subject to processing steps with predictable or measurable outcomes.

Referring to FIG. 1, system 10 is used to manage a timber yard with a sorter 102, a mill 104, and an outfeed 106 from sawmill 104. The timber yard may also include a kiln 108, a planer 110, and a planer sorter 112. The movement of products through the timber yard is managed by transport equipment 114. The timber yard also includes storage areas 116 that are accessible to the transport equipment, where raw, intermediate, or finished products are staged or stored for further processing or transport. System 10 uses a computer network with one or more processors, such as a general purpose computer 12 or purpose-built processor or multiple processors, PLC (programmable logic controller), etc. that is connected to communicate with sensors and other equipment over wired or wireless links in the computer network. In FIG. 1, solid arrows are intended to represent process flows, while arrows with dashed lines represent data flow, and a wireless network is represented by reference number 109. The computer components are used to run software that implement the steps described below. The computer network includes data storage devices, such as a main database server 14, and data input devices such as a keyboard, mouse, touch screen, or the like, represented by input block 16, and data output devices, such as a screen, audio or visual alarms, or the like (not shown). The computer network may also be capable of communicating data with other networks, such as to receive data on material being received or transmit data on products being delivered. As shown, input block 16 receives environmental data 18 from an internet connection, and main database server 14 receives order requests data 20, which may be received from online orders, entered by timber yard staff, etc. The computer network may be an existing network that is used in managing the processing facilities, and the system may be managed by installing appropriate software to run on that network. For example, computer 12 may be a timber yard tracking computer, and main database server 14 may be used to manage other aspects of the timber yard's management. Existing or new sensors may be used to provide sufficient data for the system. In the depicted example, sensors may include location sensors 22 and load cells 24 mounted to transport equipment 114. Location sensors 22 may also have an orientation sensor, which may be incorporated into location sensor 22. For example, location sensor may include two or more GPS antennae which allow the orientation of transport equipment 114 to be determined. As transport equipment 114 will have a certain size and shape, knowing the location and orientation of transport equipment 114 may be used to record a more accurate location of the package, or may be used to characterize the orientation of the package when unloaded. The orientation may also be determined using other types of sensors. In addition, other sensors may include a stationary GPS 26 connected to fixed components such as base computer 12, moisture sensors 28 at different stages, and other sensors. In addition, the computer network may gather data from the equipment itself, such as from sorter 102, mill 104, kiln 108, planer 110, etc., which may be computerized and automated to take measurements during operation that may be useful in tracking and characterizing the logs or lumber being processed.

As noted, the logs and lumber at a timber yard are generally moved using transport equipment 114, such as forklifts, skid steers, loaders, log handling machines, etc. The timber yard may have various types of transport equipment that are used for different types of transport operations. For example, a log handling machine may be used to transport sorted logs while a forklift may be used for transporting packages of milled or planed lumber. Transport equipment may also include conveyor belts and other fixed transport equipment, depending on the design of the timber yard. Location sensors 22 used in the system with respect to transport equipment may be mounted on transport equipment, such as GPS, gyroscope and accelerometers, RF-based sensors that broadcast location data, or other types of sensors that detect and calculate the location of various equipment to be tracked. By tracking transport equipment, the location of the load being transported by the transport equipment may be known based on readings from location sensors 22. Transport equipment 114 may be equipped with load cells 24 to measure the weight of the load being transferred. The measurement of a load may be based on the differential measurement between when transport equipment 114 is loaded and unloaded, whether during a loading event or an unloading event. Optical sensors (not shown) may also be used that allow video data to be processed in order to identify, track, and/or characterize objects, packages, etc. Data may also be received based on inputs by workers. As the various packages of logs and lumber are tracked, the system may be programmed to use the physical location, including height if the packages are stacked, as a unique identifier for the package. The system may maintain a database, such as in server 14, of the history and characteristics of each package, such as the age, weight, moisture, species, and dimensions of the logs or lumber. In some cases, the system may instruct the operator to unload the package in a specific location. In other cases, the operator may use their discretion on selecting an appropriate location to unload the package. Th system may be programmed to track the location of the packages in either circumstance. Where the location of the unloading event is predetermined, the system may simply verify that the instructions were followed. Alternatively, the system may record the location as measured during an unloading event.

There will now be described an example of a system to manage the lifecycle of a product in terms of a timber yard.

A timber yard receives raw material or material to be processed, such as harvested logs. The harvested logs may be cut-to-length and/or debarked before or after delivery. The harvested logs received by the timber yard may be characterized by species, weight, and/or size, and the data may be recorded in the system. The characterization may be done during delivery or provided to the timber yard at the point of delivery. The logs are sorted, such as based on species and/or size, intended use (such as lumber, plywood, chips, etc.) which may be done using a log sorting line 102 that is configured to deposits logs into the appropriate bin. As the logs are sorted, the system may instruct a transport equipment operator to move logs from a particular bin to a specified log pile. Alternatively, the system may track where a particular type of log is unloaded at the discretion of the operator and record the location as a log pile with the corresponding characteristics. Log sorting line 102 may be automated to measure and record data such as the volume, length, diameter, weight, moisture content, etc. of the logs. Alternatively, some or all of this data may be measured and recorded manually. The locations of the log piles may be defined in the system either a predetermined locations or on an ad hoc basis based on where the logs are unloaded by an operator, and the system is updated with the data that characterizes the logs in each pile. In addition, locations of other equipment, such as the location of mill 104, kiln 108, planer 110, storage area 116, etc. The locations may be further specified by the input and output, as well as sub-areas within storage area 116, or locations of specific packages of logs or lumber, including a vertical position of packages are stacked.

After the raw material has been received, the next step is generally to transport the logs to mill 104. This may be accomplished using a transport machine 114, such as a log handling machine, to collect logs from a pre-determined pile and deliver them to the input of mill 104. The location of transport machine 114, and hence the logs being transported, is tracked by the system to determine the pile from which the logs were collected and verify the delivery location, and thus characterize the load being transported. This may be in response to a request entered into the system and delivered to an operator electronically, a verbal request, or the operator's initiative. The system may automatically generate a record based on the movement of transport equipment 114 and the detection of a load, and may characterize the record based on the start and end locations. The weight or volume of the logs being delivered may be tracked, either by a load sensor on the log handling machine, by processing video data, or by a sensor at the mill (not shown). This data may then be used to update the computer system by indicating the amount of logs removed from the appropriate pile.

After delivering the logs to the mill, the logs are milled according to known processes, which may be referred to as an event, or processing event. In some examples, this may involve cutting a log by an initial saw blade, such as a head saw, that cuts planks with unfinished edges, or flitches, from the sides of the log until the log has cross-sectional shape that is square or rectangular, referred to as a cant. The flitches and cant may be processed further to produce planks or boards of a desired width, thickness, and length, such as by edging to trim any irregular edges, and trimming the ends at typical lumber lengths. Some mills may use a computer process to decide on the types of cuts to make in order to optimize the output from any given log, or the mill may be controlled manually. Lumber from the mill may then be fed into a sorter, stacked, and then taken from the outfeed 106.

The processing of the logs will result in the transformation of the logs to cut lumber, typically of different dimensions, and with a reduced combined weight. The size and shape of the lumber, and/or the weight of the lumber that is output from the mill may be recorded in the system. The output of outfeed 106 may be sorted into packages of lumber that are collected by transport equipment and moved to the next location for the next event in the lifecycle. Based on the sorting process, the system may predict the size, and weight of the package or packages, and may instruct an operator where to move the package, based on the characteristics of the package. Alternatively, the system may track the movements of transport equipment 114 to determine the location of each package.

After being processed by a mill, rough cut lumber may be dried, which may occur in kiln 108 or by storing it in a suitable location before being subjected to further processing. The drying process may be monitored, such as based on temperature, time, humidity sensors, etc., beginning and end weight, which may also be tracked by the system. The system may also track the beginning and end weight. Once dried, the lumber is removed from the kiln or other drying location by transport equipment 114, which again allows the package to be tracked based on the beginning and end locations. The system may track the movement of the package, or instruct the operator with a desired destination.

In some cases, the load sensor of transport equipment 114 may be used to detect the presence of a load and may indicate the number of packages being transported by transport equipment 114. This indication may be measured as an alternative or in addition to a more precise weight measurement. In cases where packages are stacked, detecting the number of packages loaded onto transport equipment 114 may be useful in determining the vertical location of each package and determining the specific packages that are loaded or unloaded at a specific location in the three-dimensional space of the yard.

Whether dried or not, rough cut lumber may be packaged for sale, in which case the lumber may be taken to a packaging station and/or deposited in storage area 116 to await delivery. Alternatively, the rough cut lumber may be processed by other equipment to produce

other products. For example, the rough cut lumber may be taken to planer 110 to produce planks and boards, a machine for producing laminated boards (not shown) or other equipment. The location of the rough cut wood as it is delivered to the planer or other equipment may be tracked by tracking the location of the transport equipment 114. The lumber may then be sorted and stacked a final time and packaged for eventual delivery or pickup. As with mill 104, the system may track the dimensions of the various planed board or planks, an estimated weight after being planed, the manner in which they are sorted, the differences between the packages of planed lumber and the packages of milled lumber at the input of planer 110.

In addition to cut lumber, the system may also track other streams at the sawmill, such as sawdust, bark, wood chips, etc. that is either an end product, or used in the production of other products. This may be initiated by specifying a known, pickup location that may be characterized by volume and/or weight of the material at that location (such as if the sawdust, bark, or wood chips are gathered and deposited in a particular location) or by an operator initiating the process.

The system and method described above allows timber to be tracked through its lifecycle from the delivery of logs through to the finished product by tracking the location of equipment, storage locations, and the movement of transport equipment used at the timber yard. The computer network may also be used to predict the output of different processing steps, so that the specifications of an expected package may be verified against measurements taken of the packages from the output of the previous stage. One characteristic that may be considered is the weight of a package of timber, which can be expected to vary at different stages. For example, a certain proportion of the lumber will be removed as waste when milled or planed. This may be estimated by the system based on historical data or based on calculations resulting from the cuts made. Similarly, in a kiln, a certain amount of weight will be lost as the wood dries. A weight change may also be expected as lumber is exposed to certain environmental conditions over time, such as humidity, which may cause the lumber to dry or absorb water, depending on the stage of the lifecycle. The weight measured by transport equipment may also be used to determine the number of packages being are lifted in any given lifting or transporting operation.

Another characteristic that may be considered is moisture content. As noted above, the moisture content may change over time. While changes in moisture contend may manifest as changes in weight, moisture content may also be measured directly using a moisture sensor. The moisture content may be estimated based on an initial reading, for example at a sorter or based on a moisture sensor carried by the transport equipment, environmental conditions such as temperature and humidity, the manner in which the timber or package is stored such as wrapping or storage locations, the dimensions or species of the timber, etc. The relevant variables may be tracked by the computer system, including historical weather and environmental conditions, in order to estimate the moisture content of the timber. Moisture may be a relevant factor in determining the quality or life expectancy of the timber in question, and allow an operator to may a more informed decision in fulfilling orders, estimating wastage, the likelihood or progress of rot in the package, planning downstream products from upstream inventories, etc.

The moisture content and age of a given package is useful as an indicator of the life expectancy of the package, as a package with higher moisture content tends to rot faster. The life expectancy may also depend on the species of wood, as species tend to rot at difference rates.

By tracking packages based on the locations where the timber is stored and processed and by tracking the location of the equipment moving the timber, the system allows the lifecycle to be tracked without needing to label or tag the materials or packages. The weight or other measurable characteristics may be used to help identity or verify the identity of a given package. In some cases, it may be beneficial to attach a machine-readable code to a package of timber that is readable by a reader to help identify a particular package of timber.

Throughout the process, an operator may receive directions from the computer system on what package to load or unload, and in what location. The computer system may be used to verify the identity of a given load based on the computer records. These directions may result from requests that may include a manual query from a worker, an order from a customer, or an automated system that manages processes and workflows within the timber yard. For example, based on a received request, the computer system may identify an acceptable candidate package and direct the worker to either transport or process the package.

In one implementation, the three-dimensional position (which may be tracked using Cartesian coordinates), orientation, and weight may be detected to obtain the characteristics of a product or package from a mill processing output, when it is loaded onto transport equipment. The position, orientation, and weight detection may then be used to send the characteristics of a product or package to a mill processing input when it is unloaded from transport equipment. In this case, a mill processing input or output may refer to any of a variety of processing equipment that may be used to process timber, such as logs or lumber. Mill processing stages may include, for example, log sorters, sawmills, kilns, or planer mills.

The position, orientation and weight data, combined with other characteristics, specifications, and/or environmental conditions to which it is exposed, may then be used to track the product or package throughout the manufacturing process and during storage. The environmental conditions may be used to predict how the known characteristics will change, and may be used to modify the stored characteristics of the product or package. The environmental conditions may be related to any storage location, such as log or lumber yard or kiln. For example, as environmental conditions within a kiln may vary depending on location, more accurate results may be achieved by tracking the specific position of the product or package within the kiln.

The system may be programmed to instruct the operator how to handle packages based on the characteristics of the product (original or modified) for improved efficiency and reduction of wasted product. This may include kiln loading instructions, identification of specific packages with similar or desired characteristics, instructions to move aged product to avoid spoilage, etc. The originally tracked or modified characteristics of the product may be sent to the mill processing input when the transport equipment is unloaded to improve the milling process.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A method of tracking timber packages in a timber yard, the method comprising the steps of:
milling logs to produce a plurality of timber packages, each timber package being characterized by a set of specifications;
transporting the plurality of timber packages within the timber yard using transport equipment that comprises a location sensor and a load sensor;
for each timber package:
detecting loading events when the timber package is loaded onto the transport equipment and detecting unloading events when the timber package is unloaded from the transport equipment in the timber yard, wherein:
each loading event and each unloading event comprises a detected location and a measured load; and
at least one unloading event and at least one loading event occurs at a processing location;
processing one or more timber package at the processing location such that the set of specifications are modified in a processing event; and
for each loading event, each unloading event, and each processing event, recording a package record in a computer system comprising the detected location and the set of specifications; and
comparing a loading event to the package records in the computer system to identify the timber package being loaded.

2. The method of claim 1, wherein the set of specifications is selected from a group consisting of: wood species, moisture content, event time stamps, package weight, dimensions of the timber package, dimensions of individual lumber pieces in the timber package, and combinations thereof.

3. The method of claim 1, wherein the timber yard comprises log bins comprising logs sorted according to characteristics, and wherein a location of each log bin and the characteristics are stored in the computer system as a bin record, the method further comprising the steps of:
delivering logs from log bins to the mill using the transport equipment; and
associating the location of the transport equipment with the log bins to verify characteristics of the logs being delivered to the mill.

4. The method of claim 1, further comprising the step of receiving a timber request, and directing an operator to a location of a timber package selected based on a suitable package record.

5. The method of claim 1, wherein processing the timber package comprises drying the timber package in a kiln, and the specifications comprise a moisture content of the timber package.

6. The method of claim 5, wherein processing the timber package comprises planing the timber package in a planer, at least some of the plurality of timber packages being transported from the kiln to the planer.

7. The method of claim 1, wherein a plurality of timber packages are processed in a processing facility and a plurality of processed timber packages are packaged after the processing event, the plurality of timber packages sharing at least one common characteristic such that lumber in the plurality of timber packages is fungible between the plurality of processed timber packages.

8. The method of claim 1, further comprising the steps of using the computer to estimate the modified set of specifications resulting from the processing event, and using the modified set of specifications to verify an identity of a timber package after the processing event.

9. The method of claim 1, further comprising the step of unloading one or more timber packages in a storage location of the timber yard.

10. The method of claim 1, further comprising the step of applying a machine-readable code to the timber package.

11. A lifecycle management system for a timber yard, comprising:
transport equipment configured to transport timber packages at the timber yard, the transport equipment having a location sensor and a load sensor;
at least one timber processor that processes the timber packages in processing events; and
a computer processor that is programmed to:
track a location of the transport equipment as the transport equipment loads and unloads timber packages;
store package records for each load event, unload event, or processing event of a timber package, each package record comprising a location and a set of specifications of the timber package;
identify an unknown timber package by comparing characteristics of the timber package to the stored package records; and
track the timber packages from the timber processor to one or more subsequent locations.

12. The lifecycle management system of claim 11, wherein the computer processor is programmed to receive a timber order and direct an operator to one or more timber packages that corresponds to the timber order.

13. The lifecycle management system of claim 11, wherein the at least one timber processor comprises a mill, a kiln, a planer, or combinations thereof.

14. The lifecycle management system of claim 13, comprising more than one timber processors, and the computer processor is further programmed to:
track timber packages between the more than one timber processors based on the location of the transport equipment; and
update the set of specifications for the timber packages processed by a subsequent one of the more than one timber processors.

15. The lifecycle management system of claim 11, wherein the timber yard further comprises a storage location for storing timber packages.

16. The lifecycle management system of claim 11, wherein the set of specifications is selected from a group of an age of timber, weight of timber, moisture of timber, species of timber, dimensions of timber, and combinations thereof.

17. The lifecycle management system of claim 11, wherein the computer processor is further programmed to use a physical location of a package as a unique identifier of the package.

18. The lifecycle management system of claim 11, wherein the computer is programmed to estimate a modified specification after processing by a lumber processor, and the modified specification is used to verify an identity of a processed timber package.

19. The lifecycle management system of claim 11, further comprising a code reader that is adapted to read a machine-readable code applied to timber packages.

20. The lifecycle management system of claim 10, wherein the computer processor is further programmed to manage lumber in a plurality of the timber packages that share at least one predetermined common characteristic as fungible between a plurality of processed timber packages that result from the processing event.
